(19) United States
(12) Patent Application Publication
(10) Pub. No.: US 2024/0059401 A1
(43) Pub. Date: Feb. 22, 2024

(54) AIRCRAFT UNDERCARRIAGE

(71) Applicant: BAE SYSTEMS PLC, London (GB)

(72) Inventors: Benjamin Fairfax LUXMOORE, Alton Hampshire (GB); Jacob Joseph GRUNDY, Alton Hampshire (GB); Paul Robert MCDONALD, Alton Hampshire (GB); David Paul TYLER, Alton Hampshire (GB)

(73) Assignee: BAE SYSTEMS PLC, London (GB)

(21) Appl. No.: 18/270,908

(22) PCT Filed: Dec. 16, 2021
(86) PCT No.: PCT/GB2021/053334

§ 371 Date: Jul. 5, 2023

(30) Foreign Application Priority Data
Jan. 4, 2021 (GB) 2100022.9

(51) Int. Cl. B64C 25/24; B64C 25/32; B64C 25/62

(52) U.S. Cl. CPC B64C 25/24; B64C 25/405; B64C 25/62

(57) ABSTRACT

An undercarriage unit is provided. The undercarriage unit comprises: a rotatable wheel; at least one electromagnet for releasably coupling the undercarriage unit to the aircraft; a switch for selectively activating and deactivating the at least one electromagnet; and a controller arranged to actuate the switch. An aircraft having the undercarriage unit is also provided.

### FIELD

The present disclosure relates to an undercarriage unit and an aircraft having the same.

### BACKGROUND

Increasing the mass of an aircraft results in a requirement for more power to maintain or provide its forward motion. Increased mass also requires increased lift to be generated by the aircraft's wings, which therefore requires them to have increased surface area. The increase in power requirement in turn requires more fuel, batteries or solar cells to be carried by the aircraft, which in turn adds mass. The relationship between weight and power is not linear, and therefore the aircraft quickly becomes impractically large if mass is not minimised, this is particularly noticeable on low-mass aircraft. It is also key to reduce the drag on the aircraft so as to minimise the power required to cause its forward motion, where again increased power requirement increases the mass burden.

High Altitude Long Endurance (HALE) aircraft are known. These are distinguished by their ability to remain aloft at altitudes in excess of 18,000 metres without refuelling for periods in excess of 24 hours.

To reduce the mass of HALE aircraft, they typically do not have articulating landing gear (in other words, undercarriage). Instead, they are launched from dollies, using manpower or released from other aircraft already in flight, and are forced to crash land. Launching aircraft in this manner is inefficient when conducted on a large scale. Particularly, using people to launch aircraft by running down a runway can be dangerous.

Therefore, there is a need for an apparatus for providing aircraft with the ability to self-launch without significantly adding to their mass.

### SUMMARY

According to a first aspect of the present disclosure, there is provided an undercarriage unit for an aircraft, the undercarriage unit comprising:
a rotatable wheel;
at least one electromagnet for releasably coupling the undercarriage unit to the aircraft;
a switch for selectively activating and deactivating the at least one electromagnet; and
a controller arranged to actuate the switch.

The undercarriage unit may comprise a power supply arranged to be selectively coupled to the at least one electromagnet by actuation of the switch.

The power supply may be further arranged to drive the rotatable wheel.

The undercarriage unit may comprise a wireless receiver for receiving a control signal, and the controller may be configured to actuate the switch to deactivate the at least one electromagnet in response to the control signal.

The controller may be configured to actuate the switch in response to a predetermined condition of the undercarriage unit. The predetermined condition comprises one of a velocity, altitude or strain on the undercarriage unit.

The undercarriage unit may comprise a sensor for generating condition data, and the controller may be configured to use the condition data to determine if the preconfigured condition is satisfied.

The undercarriage unit may comprise a failsafe arranged to deactivate the at least one electromagnet when the available power from the power supply drops below a threshold level.

The undercarriage unit may comprise a housing, wherein the rotatable wheel, the switch and the controller are at least partly contained within the housing. The wheel may be rotatable relative to the housing.

The undercarriage unit may comprise at least one elongate fixing member extending away from the housing, wherein a first electromagnet is coupled to the fixing member such that its central axis is outside the housing.

The at least one electromagnet may be coupled to the housing or the at least one fixing member by a suspension member providing variable vertical displacement of the electromagnet. The suspension member may comprise a sprung bolt. The sprung bolt may comprise a helical compression spring, or a conical spring. Alternatively, the suspension member may comprise a leaf spring, or a sprung material such as a foam.

The at least one electromagnet may be pivotably attached to the fixing member or the housing.

According to a second aspect of the present invention, there is provided an aircraft comprising at least one detachable undercarriage unit according to the first aspect.

The aircraft may be a high altitude long endurance (HALE) unmanned aerial vehicle. Alternatively, the aircraft may be a glider.

The aircraft may comprise a filler material disposed between an aircraft structure and the at least one electromagnet to provide a flat surface. The filler material may comprise a magnetic material. Alternatively, the filler material may comprise an adhesive paste. Alternatively again, the filler material may comprise a moulded part. The moulded part may be formed using additive layer manufacturing.

It will be appreciated that features described in relation to one aspect of the present disclosure can be incorporated into other aspects of the present disclosure. For example, an apparatus of the disclosure can incorporate any of the features described in this disclosure with reference to a method, and vice versa. Moreover, additional embodiments and aspects will be apparent from the following description, drawings, and claims. As can be appreciated from the foregoing and following description, each and every feature described herein, and each and every combination of two or more of such features, and each and every combination of one or more values defining a range, are included within the present disclosure provided that the features included in such a combination are not mutually inconsistent. In addition, any feature or combination of features or any value(s) defining a range may be specifically excluded from any embodiment of the present disclosure.

### BRIEF DESCRIPTION OF THE DRAWINGS

Embodiments of the disclosure will now be described by way of example only and with reference to the accompanying drawings, in which:

FIG. 1 is a perspective view of a HALE aircraft according to an embodiment;

FIG. 2 is a perspective view of an undercarriage unit according to an embodiment;

FIG. 3 is a perspective view of an electromagnet arrangement according to an embodiment;

FIG. 4a is a side view of an undercarriage unit and wing member according to an embodiment;

FIG. 4b is a perspective view of an undercarriage unit and wing member according to an embodiment;

FIG. 5 is a system diagram of an undercarriage unit according to an embodiment; and

FIG. 6 is a system diagram of an undercarriage unit according to another embodiment.

For convenience and economy, the same reference numerals are used in different figures to label identical or similar elements.

### DETAILED DESCRIPTION

Generally, embodiments herein relate to a releasable (i.e. detachable) undercarriage unit for use on an aircraft, specifically but not exclusively a HALE aircraft. The undercarriage unit is also readily applicable to other types of aircraft, both manned and unmanned. Such aircraft include manned gliders or medium altitude long endurance (MALE) aircraft. The undercarriage unit may be powered or unpowered. The undercarriage unit comprises at least one electromagnet for coupling the undercarriage unit to the underside of the aircraft. The electromagnet may be controlled by a remote user to release the undercarriage unit, or the undercarriage unit may comprise a controller for deactivate the electromagnet once a predetermined condition (such as forward velocity, altitude or battery capacity) is achieved.

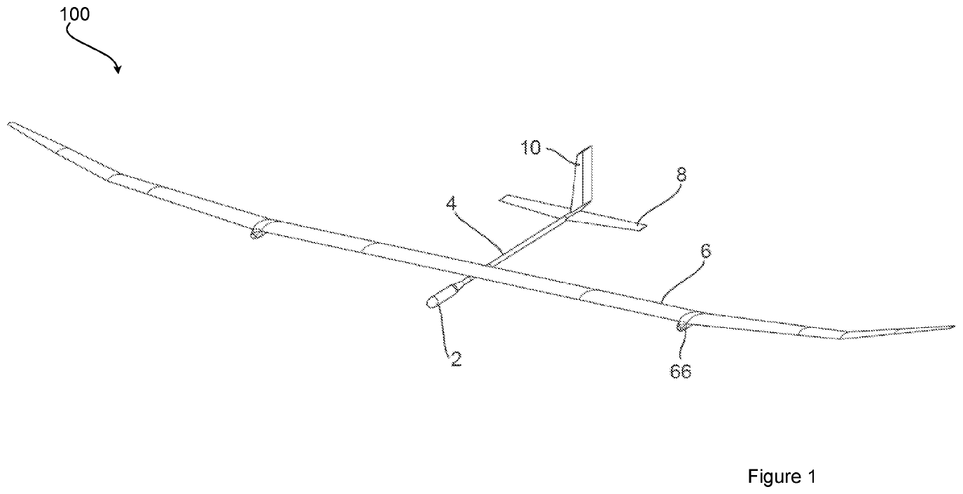

An aircraft 100, specifically a high altitude long endurance (HALE) unmanned aeroplane, is shown in FIG. 1. While a HALE aircraft is illustrated here, it would be readily appreciated that the present invention is applicable to other types of aircraft, particularly those on a stringent mass budget such as spacecraft, small unmanned aerial vehicles (UAVs) such as those used for reconnaissance, aerial target drones, and gliders.

A HALE aircraft typically operates at altitudes of around 20,000 metres. Long endurance means a non-stop flight having a duration of greater than about 24 hours, but preferably greater than about 1 month. Even more preferably, a long endurance aircraft is capable of sustained flight for up to about 90 days. Even more preferably, the HALE aircraft is capable of sustained flight for up to about 180 days. In an exemplary embodiment, the HALE aircraft is capable of sustained flight for up to at least 1 year. Sustained flight means the period between the aircraft taking off and finally landing (or ceasing controlled flight) is not interrupted by the aircraft landing.

The aircraft 100 includes a wing member 6. An example HALE aircraft has a wing span of about 35 metres and a relatively narrow chord (i.e. of the order 1 metre). The wing member 6 is coupled to a fuselage 4. To aerodynamically balance the aircraft 100, a horizontal tailplane 8 and a vertical tail fin (or vertical stabilizer) 10 are coupled to the rear of the fuselage 4. In the illustrated example, a payload module 2 is coupled to the front of the fuselage 4, i.e. the nose of the aircraft 100. In other embodiments, the payload may be stored inside the fuselage 4 itself rather than in a modular unit. An engine 66 having a propeller is mounted to the wing member 6 on both sides of the fuselage 4. It would be appreciated that this aircraft configuration is merely an example of one which could benefit from the present invention, and is not intended to be limiting.

The aircraft 100 is of lightweight construction. For example, the fuselage 4, wing member 6, payload module 2, tailplane 8 and tail fin 10 are made of a monocoque carbon fibre laminate skin structure. In other words, the skin forms the aircraft's body. In other embodiments, the body is substantially made of a lightweight metal, such as titanium, titanium alloy, aluminium or aluminium alloy.

The aircraft 100 may be manned or unmanned. It may be controlled to take off, manoeuvre and land from a control station or using a handheld controller. Alternatively, the aircraft 100 may comprise a processor configured to receive sensor data and use it to generate control signals used to control the aircraft's control surfaces (i.e. ailerons, elevators and flaps) such that it takes off, manoeuvres and lands. The aircraft 100 may be controlled to land at the same airfield from which it took off.

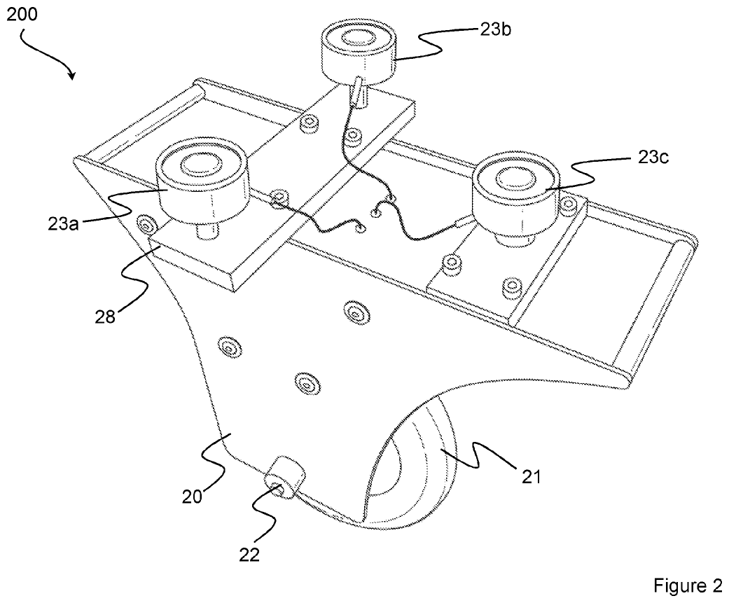

The weight of the aircraft 100 is minimised by not including fixed undercarriage (where here, “fixed” is a term used to contrast with “detachable” rather than “retractable” undercarriage). Instead, the aircraft 100 comprises one or more detachable undercarriage units 200/300, as will be described with reference to FIGS. 2 to 6. The undercarriage units 200/300 are releasably attached to the underside of the aircraft 100. For example, one undercarriage unit 200/300 may be attached under the wing member 6 on each side of the fuselage 4, and one may be attached under the fuselage 4 at the tail end of the aircraft 100. Alternatively, an undercarriage unit 200/300 may be attached under the fuselage 4 at the nose of the aircraft 100. The number, configuration and spacing of undercarriage units 200/300 will depend on the weight, size and type of aircraft 100 to which they are attached.

FIG. 2 shows an undercarriage unit 200 according to an embodiment for use on the aircraft 100 shown in FIG. 1. The undercarriage unit 200 comprises a housing 20. A wheel 21 extends from the bottom of the housing 20 such that the bottom of the housing 20 does not directly contact the ground when the undercarriage unit 200 is upright. The wheel 21 is rotatably attached to the housing 20 by way of an axle 22.

In the illustrated embodiment, the housing 20 comprises a single vertical side surface and a top surface member coupled perpendicular to the upper part (i.e. end) of the side surface. The top surface is horizontal to the ground when the undercarriage unit 200 is upright, and is elongate in the direction of travel of the wheel 21. The upper part (or top) of the side surface is the end of side surface opposite the bottom having the wheel 21 protruding therefrom. The axle 22 is arranged substantially perpendicular to the side surface. The axle 22 extends through the side surface. While in the illustrated embodiment the axle 22 is fixed and the wheel 21 rotates about the axle 22, in other embodiments the wheel 21 is fixed to the axle 22 and the axle 22 is arranged to rotate relative to the housing 20.

In another embodiment, the housing 20 comprises two spaced-apart vertical side surfaces coupled together at their upper ends by the top surface. The wheel 21 and axle 22 are disposed in the space formed between the two side surfaces. In this embodiment, instead of passing through both side surfaces, the axle 22 may terminate in a recess in an inside surface of each of the side surfaces.

Other embodiments may include more than one wheel 21 within the same housing 20. The housing 20 is a substantially open structure, with an open front and rear (relative to the direction of rotation of the wheel 21), so as to minimise the mass of the undercarriage unit 200. However, in other embodiments the housing 20 may be a substantially closed structure with the wheel 21 being enclosed at its ends by an aerodynamic fairing, which tends to improve aerodynamic performance at high speeds. While the side surface is illustrated as being a planar uniform structure, in other embodiments it may comprise apertures, or may be a framework structure or single arm.

The housing 20 is made of carbon fibre. In other embodiments, the housing 20 is made of a lightweight metal, such as titanium, titanium alloy, aluminium or aluminium alloy. The housing 20 may be formed using additive layer manufacturing, and as such may be made of plastic. The wheel 21 comprises a plastic core with a rubber tyre, although it would be appreciated by the skilled person that any appropriate wheel 21 may be selected.

Three electromagnets 23a-c (generally 23) are attached to the upper side of the top surface of the housing 20, in use facing towards the underside of the aircraft 100. Three electromagnets 23 arranged on the top surface of the housing 20 have been found to be optimal for use on an aircraft 100 of the type shown in FIG. 1. Two electromagnets 23a,b are disposed laterally adjacent each other towards the leading edge (i.e. front) of the top surface, with a single electromagnet 23c disposed along the centre axis of the top surface towards the trailing edge (i.e. rear).

The electromagnets 23 may be coupled directly to the top surface of the housing 20, or may be coupled to fixing members 28 fixed to the housing 20 as illustrated in FIG. 2. By attaching an elongate fixing member 28 perpendicular to the top surface of the housing 20 such that it overhangs the top surface, the spacing between electromagnets 23a,b can be increased to distribute load more evenly. In other words, the lateral spacing between electromagnets 23 can be made wider than the width of the housing 20 by coupling the electromagnets to the fixing member 28. Alternative to the single long fixing member 28 in the illustrated arrangement, a first fixing member may protrude from a first side of the housing 20 and a second fixing member may protrude from the side of the housing 20 opposite the first side. First and second electromagnets 23a, 23b are then respectively coupled to the first fixing member and second fixing member.

The skilled person would appreciate that other configurations of electromagnets 23 may suit different applications. For example, in other embodiments, the undercarriage unit 200 may comprise more or fewer than three electromagnets 23. Further, their arrangement on the top surface may be different to what is shown here, for example, the electromagnets 23 may be arranged along the centre axis of the top surface.

It is advantageous to provide the electromagnets 23 on the undercarriage unit 200 rather than on the underside of the aircraft 100, as in this arrangement the electromagnets 23 do not add to the mass burden on the aircraft 100 once it is in the air and the undercarriage unit 200 has been detached. However, the skilled person would appreciate the electromagnets 23 could instead be provided on the aircraft 100 and powered by its on-board power source in cases where mass budget is not so critical.

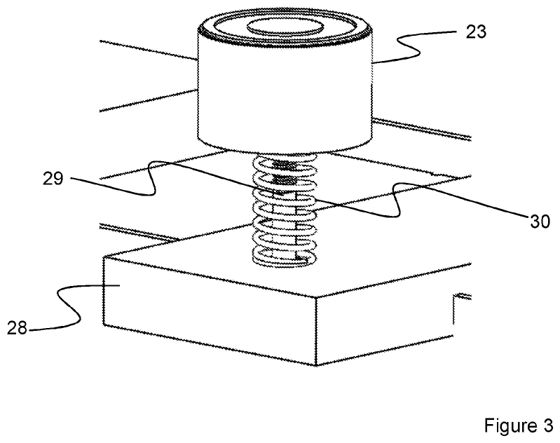

FIG. 3 shows a magnified view of coupling an electromagnet 23 coupled to the fixing member 28. A similar technique can be used to couple the electromagnet 23 directly to the housing 20.

The fixing member 28 comprises an aperture. A bolt 30 is inserted through the aperture. The bolt 30 is prevented from moving all the way through the aperture by a bolt head and optionally a washer. The electromagnet 23 is attached to the top of the bolt 30, that being the end opposite the bolt head. The electromagnet 23 may be screwed to the bolt or attached by any other suitable means. The electromagnet 23 may be coupled to the bolt 30 by a hinge or universal joint such that its angle relative to the plane of the top surface of the housing 20 can be adjusted to suit the shape of the structure to which it is to be magnetically attached.

A spring (i.e. damper) 29 surrounds the portion of the bolt 30 protruding from the fixing member 28. The spring 29 restricts the movement of the bolt 30 along its longitudinal axis. This provides freedom to adjust the vertical position of the electromagnet 23 relative to the plane of the top surface of the housing to suit the shape of the structure on the aircraft 100 to which it is to be magnetically attached. The spring 29 as illustrated is a helical compression spring, although it would be appreciated a conical spring would be equally suitable. By oversizing the aperture for the bolt 29 and providing a spring 30, the electromagnet 23 can be provided with a limited ability to tilt relative to the fixing member 28 or housing 20. Therefore, the electromagnet 23 is provided with limited movement in all axes, limiting the negative effect of manufacturing imperfections and therefore the weakening of the magnetic bond with the aircraft 100.

Together, the bolt 30 and spring 29 form a sprung bolt. In other embodiments, instead of a sprung bolt, the electromagnet 23 is coupled to the fixing member 28 or the top surface of the housing 20 by a spring only. The spring may be a leaf spring. Alternatively again, the electromagnet 23 may be coupled to the fixing member 28 or the top surface of the housing 20 by a compressible material such as elastic or foam.

In addition to providing the degrees of freedom discussed above, the spring 29 or other suspension member also acts as a conventional suspension system to smooth out the effect of any undulation in the terrain over which the aircraft 100 is rolling.

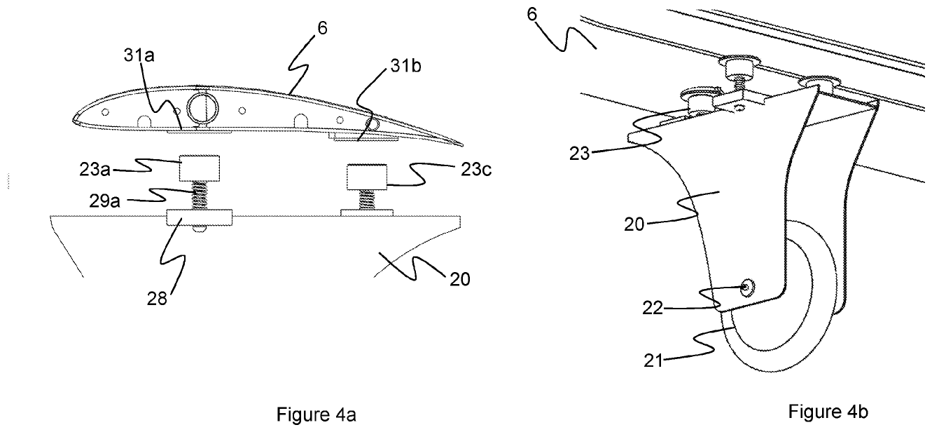

FIGS. 4a and 4b show the sequence of the undercarriage unit 200 being brought into contact with a structure of the aircraft 100 (in this case, the wing member 6 of the aircraft 100).

A plurality of magnetic plates 31a, 31b (generally 31) are disposed on the underside of the wing member 6. Each magnetic plate 31 corresponds with a respective electromagnet 23. In other words, if an undercarriage unit 200 comprises three electromagnets 23 arranged at apexes of a triangle, the underside of the wing member 6 comprises three magnetic plates 31 arranged at apexes of a triangle of the same size.

The magnetic plate 31 may be made of a magnetic metal such as cobalt or steel.

The plates 31 are in the form of platforms. A filler material may be applied to a curved surface of the wing member 6 using template or mould. The filler material is then levelled off to provide a flat surface to which to attach the magnetic plate 31. The filler material may have adhesive properties; alternatively, a separate adhesive layer may be applied to the flat surface of the filler material for attaching the magnetic plate 31. The filler material may be a liquid or paste, which cures to form a hard surface. Alternatively, the filler material may be a moulded (i.e. pre-formed) to match the shape of the lower surface of the wing member 6 on one side, and provide a flat surface on the other side. Here, the filler material may be formed using additive layer manufacturing.

In an alternative embodiment, the filler material is a liquid metal or metallic paste that is applied to the lower surface of the wing member 6 and cures to form the magnetic plate 31.

The template used to position the magnetic plates 31 may be arranged to match the layout of electromagnets 23 on the undercarriage unit 200.

By providing each magnetic plate 31 in the same plane as the other magnetic plates 31, using the filler material to effectively change the shape of the lower side of the wing member 6, an overall stronger magnetic bond tends to be formed between the electromagnets 23 and magnetic plates 31.

The magnetic plates 31 are slightly larger in diameter (or surface area) than the diameter (or surface area) of the electromagnets 23. This tends to allow the electromagnets 23 to move slightly relative to the magnetic plates 31 when shocked hard, rather than breaking contact.

In an alternative embodiment, one large magnetic plate 31 is provided, to which all of the electromagnets 23 magnetically attach. While a simpler design, than the preceding embodiment, and therefore easier to manufacture and attach electromagnets to, having excess unused metal area tends to add unnecessary weight to the aircraft 100.

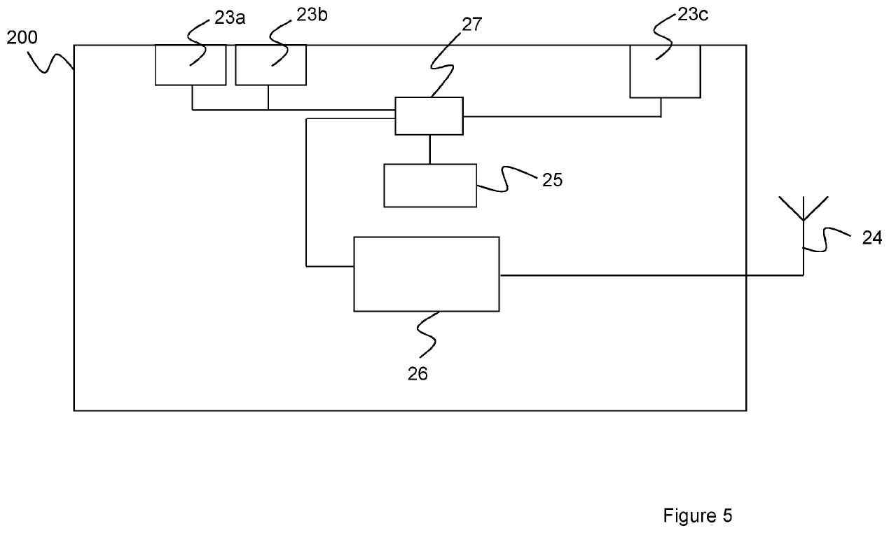

A system view of the undercarriage unit 200 is shown in FIG. 5. Here, the electromagnets 23a-c are electrically connected to a power source 25. The power source 25 is preferably a rechargeable battery, but may be any suitable power source such as a capacity, generator, or photovoltaic cell. A switch 27 can be actuated by a controller 26 to connect the power source 25 to the electromagnets 23 in order to selectively power them. In other embodiments, the switch 27 is integrated with the power source 25 and the controller 26 is arranged to actuate the switch 27 to activate and deactivate the power source 25.

The controller 26 may take any suitable form. For instance, it may be a microcontroller, plural microcontrollers, a processor, or plural processors. The controller 26 may comprise further components that enable it to perform its function, such as memory (e.g. random access memory), software, firmware, and a cooling system. The controller 26 may comprise its own internal power source (such as a button battery), or may draw power from the undercarriage unit's power source 25.

When power is supplied to the electromagnets 23 from the power source 25, they are energised so as to couple to a magnetic plate (or other magnetic structure) 31 on the underside of the aircraft 100.

A fail safe is provided, such that when the power source 25 powering the electromagnets 23 runs flat (or otherwise fails), the undercarriage unit 200 releases from the aircraft 100 despite the command to release not being generated.

In the illustrated embodiment, the controller 26 receives a control signal through a wireless receiver 24. The wireless receiver 24 may be any suitable receiver for receiving a signal from a remote handheld device or ground station, such as a WiFi receiver, FM radio receiver, cellular communications receiver (4g, 5g, 6g, etc.), or Bluetooth™ receiver. In response to the control signal, the controller 26 generates a corresponding command to either release or engage the electromagnets 23. For example, when a user transmits a control signal, via the wireless receiver 24, to detach the undercarriage unit 200, the controller 26 receives and processes that control signal, and in response generates a command for the switch 27 to disengage power from the electromagnets 23.

The power source 25 may further be arranged to drive the wheel 21, such that the undercarriage unit 200 is self-propelled rather than being driven by thrust from the aircraft's engines 66. Alternatively, the undercarriage unit 200 may be free-wheeling, such that the wheel 21 cannot rotate unless coupled to the aircraft 100 and the aircraft 100 is driven by its engines 66.

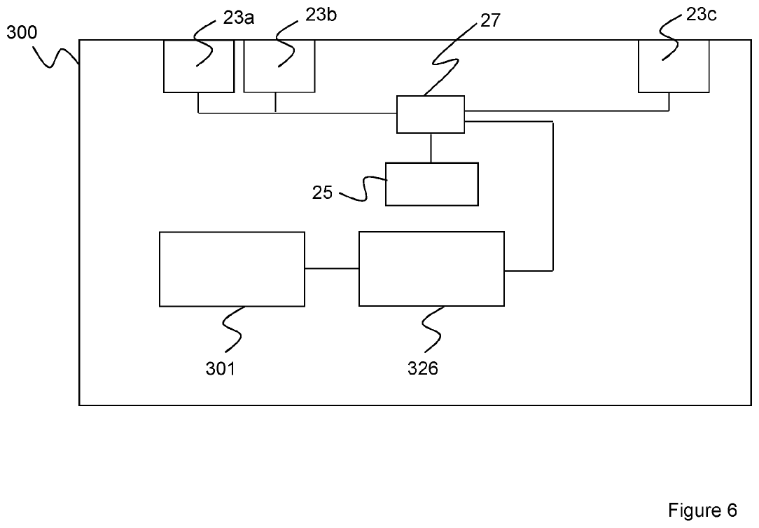

An undercarriage unit 300 according to an alternative embodiment is illustrated by way of a system diagram in FIG. 6. Here, components which are identical to those of the embodiment described with reference to FIG. 5 are given the same reference numerals and will not be described again. The undercarriage unit 300 does not have a wireless receiver 24 according to this embodiment.

In the embodiment illustrated in FIG. 6, a sensor 301 is arranged in communication with the controller 326. The sensor 301 is, for example an inertial measurement unit (e.g. a pitot tube and data processor), an altimeter, tachometer, fuel gauge, capacity metre, or strain gauge. The sensor 301 therefore gathers data such as the velocity of the undercarriage unit 300, cadence of the wheel 21, or altitude of the undercarriage unit 300. Where the sensor 301 is a strain gauge, the sensor 301 may measure the strain on the coupling between the aircraft 100 and the undercarriage unit 300. The strain will be higher when the wheel 21 has lifted off the ground (i.e. that the aircraft 100 has achieved flight), as the ground will no longer support the weight of the undercarriage unit 300.

The controller 326 is configured to use the data gathered by the sensor 301 to determine whether to deactivate the electromagnets 23. For example, when it is determined that the aircraft 100, coupled to the undercarriage unit 300, has reached a predetermined velocity or altitude, the controller 326 generates a control signal to deactivate the electromagnets 23. In another example, where the sensor 301 is a fuel gauge or capacity metre, the sensor 301 may measure the remaining capacity or fuel within the power source 25. When the remaining available power drops below a threshold level, the controller 326 is configured to deactivate the electromagnets 23.

Advantageously, use of the undercarriage unit 200/300 tends to assist in launch of an aircraft 100 into the air without the aircraft 100 having to carry the mass of the undercarriage. This tends to improve the duration, range and payload capacity of the aircraft 100, while minimising logistical burden and safety concern as there is no need for multiple users to run along with the aircraft to launch it. The use of electromagnets 23 further tends to alleviate the problem of retractable or releasable undercarriage “sticking”, as can be the case with mechanical release mechanisms.

In embodiments described above, the power source 25 is provided on-board the undercarriage unit 200/300. However, in alternative embodiments, the undercarriage unit 200/300 and aircraft 100 comprise an electrical interface to allow the electromagnets 23 to draw power from the aircraft's on-board power source. This is less preferable than the described embodiments as it will reduce the capacity of the aircraft's power source at the beginning of the flight. Rechargeable batteries have a finite number of recharge cycles, which means long endurance aircraft need to reduce use of batteries where possible.

In further embodiments, some or all of the electronic components described above as being part of the undercarriage unit 200/300 are instead part of the aircraft 100. Here, for example, the electromagnets are present on the underside of the aircraft 100 and couple to a magnetic plate 31 or other magnetic structure on an upper surface of the undercarriage unit. The aircraft's main avionics may be used to process a signal received via its wireless receiver to decide whether to disengage the electromagnets. While minimising complexity of the undercarriage unit and overall mass as there is reduced duplication of components, these embodiments are disadvantageous again as they draw on the aircraft's finite power source, and the fixed electromagnets add significant parasitic mass to the airframe.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Singular references do not exclude a plurality; thus, references to ‘a’, can′, ‘first’, ‘second’, etc. do not preclude a plurality. In the claims, the terms “comprising” or “including” do not exclude the presence of other elements.

Where, in the foregoing description, integers or elements are mentioned that have known, obvious, or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as optional do not limit the scope of the independent claims. Moreover, it is to be understood that such optional integers or features, while of possible benefit in some embodiments of the disclosure, may not be desirable, and can therefore be absent, in other embodiments.

1. An undercarriage unit for an aircraft, the undercarriage unit comprising:
a rotatable wheel;
at least one electromagnet for releasably coupling the undercarriage unit to the aircraft;
a switch for selectively activating and deactivating the at least one electromagnet; and
a controller arranged to actuate the switch.

2. The undercarriage unit according to claim 1, comprising a power supply arranged to be selectively coupled to the at least one electromagnet by actuation of the switch.

3. The undercarriage unit according to claim 2, wherein the power supply is further arranged to drive the rotatable wheel.

4. The undercarriage unit according to claim 1, comprising a wireless receiver for receiving a control signal, and wherein the controller is configured to actuate the switch to deactivate the at least one electromagnet in response to the control signal.

5. The undercarriage unit according to claim 1, wherein the controller is configured to actuate the switch in response to a predetermined condition of the undercarriage unit.

6. The undercarriage unit according to claim 5, wherein the predetermined condition comprises one of a velocity, altitude, or strain on the undercarriage unit.

7. The undercarriage unit according to claim 5, comprising a sensor for generating condition data, and wherein the controller is configured to use the condition data to determine if the preconfigured condition is satisfied.

8. The undercarriage unit according to claim 1, comprising a housing, wherein the rotatable wheel, the switch and the controller are at least partly contained within the housing.

9. The undercarriage unit according to claim 8, comprising at least one elongate fixing member extending away from the housing, wherein a first electromagnet is coupled to the fixing member such that its central axis is outside the housing.

10. The undercarriage unit according to claim 9, wherein the at least one electromagnet is coupled to the housing or the at least one fixing member by a suspension member providing variable vertical displacement of the electromagnet.

11. The undercarriage unit according to claim 10, wherein the suspension member comprises a sprung bolt.

12. The undercarriage unit according to claim 10, wherein the suspension member comprises a leaf spring.

13. The undercarriage unit according to claim 8, wherein the at least one electromagnet is pivotably attached to the fixing member or the housing.

14. An aircraft comprising at least one detachable undercarriage unit according to claim 1.

15. The aircraft according to claim 14, wherein the aircraft is a high altitude long endurance (HALE) unmanned aerial vehicle.

16. The aircraft according to claim 14, comprising a filler material disposed between an aircraft structure and the at least one electromagnet to provide a flat surface.

17. The aircraft according to claim 16, wherein the filler material comprises a magnetic material.

18. The undercarriage unit according to claim 9, wherein the at least one electromagnet is coupled to the housing or the at least one fixing member by a suspension member providing variable vertical displacement of the electromagnet, wherein the suspension member comprises a sprung bolt or a leaf spring.

19. The undercarriage unit according to claim 2, wherein the controller is configured to actuate the switch in response to a predetermined condition of the undercarriage unit.

20. The undercarriage unit according to claim 3, wherein the controller is configured to actuate the switch in response to a predetermined condition of the undercarriage unit.
